(19) United States
(12) Patent Application Publication
(10) Pub. No.: US 2026/0178888 A1
(43) Pub. Date: Jun. 25, 2026

(54) GENERATING EVALUATION DATASETS FOR RETRIEVAL-AUGMENTED GENERATION SYSTEMS

(71) Applicant: Intuit Inc., Mountain View, CA (US)

(72) Inventors: Spriha AWASTHI, Superior, CO (US); Pankaj RASTOGI, Fremont, CA (US); Deepak KUMAR, Fremont, CA (US)

(21) Appl. No.: 18/991,291

(22) Filed: Dec. 20, 2024

(51) Int. Cl. G06N 3/0475; G06N 3/0455; G06N 3/088

(52) U.S. Cl. CPC G06N 3/0475; G06N 3/0455; G06N 3/088

(57) ABSTRACT

Certain aspects of the disclosure provide a method for generating an evaluation dataset. The method may include accessing a plurality of vector embeddings associated with a plurality of documents, wherein each vector embedding corresponds to a document; clustering the plurality of vector embeddings into a plurality of clusters; selecting, from each cluster of the plurality of clusters, a subset of vector embeddings of the plurality of vector embeddings according to a sampling strategy; for each respective vector embedding of the subset of vector embeddings: generating a seed question based on content of the portion of the document associated with the respective vector embedding; transforming the seed question into a transformed question of a question type different from the seed question; and associating the transformed question with the respective vector embedding as a ground truth label; and forming an evaluation dataset comprising the transformed questions and their associated ground truth labels.

### BACKGROUND

### Field

Aspects of the present disclosure relate to retrieval-augmented generation systems.

### Description of Related Art

In recent years, large-scale document repositories have grown increasingly complex, spanning numerous domains and content types. Researchers and developers rely on various machine learning techniques, including language models and vector embeddings, to manage these sprawling data sets. A common management approach involves converting documents into semantic embeddings, which capture contextual meaning and facilitate scalable retrieval operations. Such semantic embeddings allow for more intuitive and dynamic querying, enabling information retrieval systems to locate relevant content beyond simple keyword matches. As new models and techniques continue to emerge, the ecosystem supporting these advanced retrieval methods has expanded to include robust pipelines, specialized indexing solutions, and configurable query parameters.

Despite these advancements, evaluating the performance of information retrieval pipelines remains a non-trivial task. Traditional evaluation methods often rely on manually curated datasets or pre-labeled benchmarking resources. However, manually generated datasets can be costly, time-consuming, and limited in scope. Attempts to automate evaluation data generation frequently produce repetitive or narrowly focused queries, providing an incomplete picture of system performance. Without sufficiently diverse or representative evaluation criteria, developers and stakeholders may not understand how different retrieval configurations impact overall quality or how well retrieval systems adapt to various domains.

### SUMMARY

Certain aspects provide a method for generating an evaluation dataset. The method may comprise: accessing a plurality of vector embeddings associated with a plurality of documents, wherein each vector embedding of the plurality of vector embeddings corresponds to at least a portion of a document of the plurality of documents; clustering the plurality of vector embeddings into a plurality of clusters; selecting, from each cluster of the plurality of clusters, a subset of vector embeddings of the plurality of vector embeddings according to a sampling strategy; for each respective vector embedding of the subset of vector embeddings: generating a seed question based on content of the portion of the document associated with the respective vector embedding; transforming the seed question into a transformed question of a question type different from the seed question; and associating the transformed question with the respective vector embedding as a ground truth label; and forming an evaluation dataset comprising the transformed questions and their associated ground truth labels.

Another aspect may provide a method for evaluating and refining operational parameters of an information retrieval system. The method may comprise: accessing an evaluation dataset comprising a plurality of input queries and corresponding reference outputs; applying a first configuration of the information retrieval system to at least a subset of the input queries, the first configuration specifying at least one operational parameter for locating and providing information in response to the input queries; obtaining retrieved results from the information retrieval system for the subset of queries using the first configuration; comparing the retrieved results to the corresponding reference outputs to determine a first performance metric; modifying at least one operational parameter of the information retrieval system to form a second configuration that differs from the first configuration; applying the second configuration to at least the subset of queries and obtaining updated retrieved results; comparing the updated retrieved results to the corresponding reference outputs to determine a second performance metric; and based on a comparison of the first performance metric and the second performance metric, selecting a configuration that improves the performance of the information retrieval system.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system for generating an evaluation dataset from a plurality of documents in accordance with aspects of the present disclosure.

FIG. 2 depicts an example data processing pipeline for generating a set of evaluation questions from the representative cluster samples in accordance with aspects of the present disclosure.

FIG. 3 depicts an example configuration of data entries within an evaluation dataset generated in accordance with aspects of the present disclosure.

FIG. 4 depicts an example retrieval evaluation pipeline in accordance with aspects of the present disclosure.

FIG. 5 depicts an example method for generating an evaluation dataset in accordance with aspects of the present disclosure.

FIG. 6 depicts an example method for evaluating and refining operational parameters of an information retrieval system, in accordance with aspects of the present disclosure.

FIG. 7 depicts an example processing system with which aspects of the present disclosure can be performed.

FIG. 8 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically generating and managing evaluation datasets for assessing information retrieval systems.

In some aspects, techniques for creating evaluation datasets that can be used to test and improve information retrieval systems are described. Such techniques may involve analyzing collections of documents, converting portions of the documents into embedding vectors that capture their meaning, grouping similar content together based on the embedding vectors, and generating diverse test questions that can evaluate how well retrieval systems perform across different types of queries and content areas.

Current approaches to evaluating information retrieval systems face several technical challenges. Manual creation of evaluation datasets is time-consuming and often limited in scope. Automated approaches tend to generate repetitive or overly simplistic test cases that do not adequately measure system performance. Additionally, existing evaluation methods may not assess how well systems handle complex queries that require combining information from multiple sources or applying logical reasoning.

Techniques disclosed herein address these challenges using a multi-step approach. In some aspects, documents are converted into vector representations that capture their semantic meaning. These vectors may then be grouped into clusters of related content. Representative samples of content may be selected from each cluster using one or more sampling strategies. For each selected sample, an initial “seed” question may be generated and transformed into more complex variations that test different aspects of retrieval capability. The result is an automatically generated evaluation dataset that includes diverse question types and corresponding ground truth answers.

This technical solution provides several key advantages. Aspects described herein may reduce the time and effort required to create evaluation datasets while ensuring broader coverage of different content types. The clustering and sampling strategies described provide both an evaluation dataset based on common and rare topics that may occur in the documents. The transformation of questions into different complexity levels enables more thorough testing of retrieval system capabilities.

### Example System for Generating Samples of an Evaluation Dataset

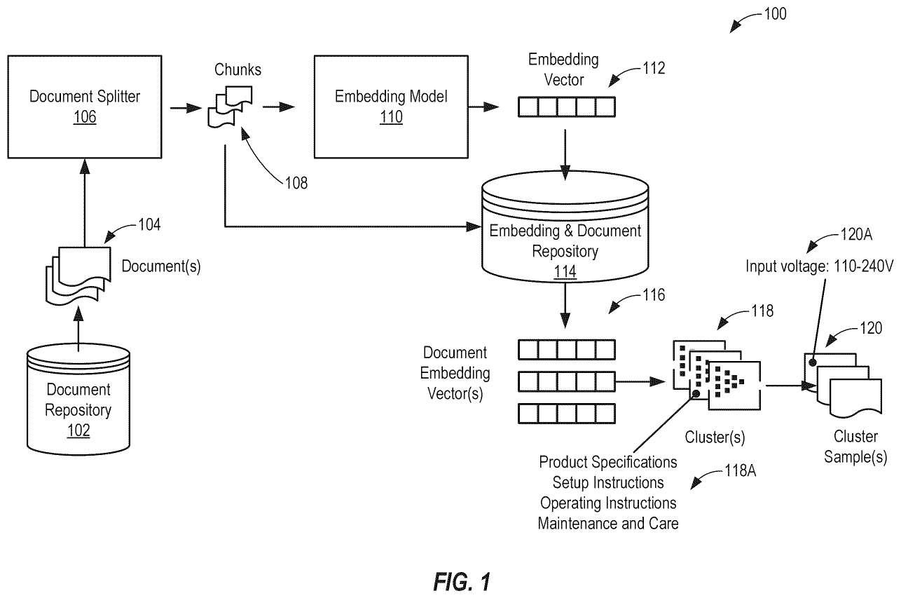

FIG. 1 depicts an example system 100 for generating an evaluation dataset from a plurality of documents in accordance with aspects of the present disclosure. In some aspects, the system 100 transforms raw textual content into semantically meaningful embeddings, organizes those embeddings into thematic clusters, and selects representative samples from these clusters to generate an evaluation dataset. As depicted in FIG. 1, the system 100 may include a document repository 102 configured to store one or more documents 104. The documents 104 may include various types of content, such as product manuals, instructions, technical specifications, articles, or any other suitable textual data. In some aspects, documents 104 may include content other than text content. For example, the documents 104 may include images, graphs, charts, structured and unstructured data, etc. In some aspects, the document repository 102 may be implemented as a file store, database, or other form of digital storage.

To prepare the documents 104 for semantic embedding, a document splitter 106 receives the documents 104 and segments the documents into discrete portions, referred to as “chunks” 108. The document splitter 106 may apply various partitioning strategies to obtain the chunks 108. For instance, the documents 104 can be divided into fixed-length segments, delineated by headings or paragraphs, or separated based on other contextual cues. The document splitter 106 may generate coherent and manageable textual units (e.g., chunks 108) that can be represented as embeddings for downstream analysis and tasks.

Once the chunks 108 are generated, an embedding model 110 may process each chunk 108 to generate a corresponding embedding vector 112. The embedding model 110 may be implemented using machine learning or deep learning techniques capable of capturing semantic relationships between words, phrases, or sentences. For example, transformer-based models, sentence encoders, or other neural network architectures may be used as the embedding model 110. Each embedding vector 112 may encapsulate semantic attributes of the corresponding chunk 108, such that comparison and clustering based techniques can be applied based on meaning rather than simple keyword overlap.

The embedding vectors 112 may be stored, along with their associated chunks 108 and original document identifiers, in an embedding and document repository 114. In this manner, the embedding and document repository 114 may be a centralized store maintaining both raw text segments and their vector representations. In some aspects, one or more of the embedding vectors 112, chunks 108, or original document identifiers may be stored separately, for example, in distinct databases or storage systems.

After performing semantic embedding and storing the embedding vectors in the embedding and document repository 114, the system 100 may apply one or more clustering operations to a collection of document embedding vectors 116 retrieved from the embedding and document repository 114. Clustering may be implemented to identify sets of semantically related chunks (e.g., chunks 108) that share common topical themes, technical attributes, or conceptual domains. As an example, as depicted in FIG. 1, the documents 104 may cover different types of information such as product specifications, setup instructions, operating instructions, and maintenance or care guidelines. In the depicted example, a cluster 118A may include chunks related to a particular product's voltage requirements (e.g., “Input voltage: 110-240V”) 120A, while another cluster may focus on maintenance steps or installation procedures. A variety of supervised and unsupervised machine learning algorithms may be used for clustering such documents. For example, techniques such as k-means clustering, hierarchical clustering, density-based clustering, may be employed. The result of applying clustering is a plurality of clusters 118, each grouping together chunks (e.g., chunks 108) with similar semantic content. In some aspects, clustering may occur at the chunk level rather than the document level, such that a cluster 118A may include chunks drawn from multiple different documents, all related to a particular topic (e.g., input voltage requirements: “Input voltage: 110-240V”).

In certain aspects, a k-means algorithm may be used to cluster the chunks 108 when the desired number of clusters is known, such as when a domain expert knows in advance how many topical categories may be desired. Alternatively, or in addition, hierarchical clustering techniques may provide the system or users a hierarchy of topics that can be selected at a level of granularity that best suits a dataset. For example, starting with a broad categorization, users can “cut” the hierarchical tree at various depths to produce a larger or smaller number of topical groups. In some aspects, density-based clustering approaches can be used, such as but not limited to, density-based spatial clustering of applications with noise (DBSCAN) or hierarchical density-based spatial clustering of applications with noise (HDBSCAN), which can be utilized to identify clusters of arbitrarily shaped boundaries and automatically detect outliers. Unlike traditional clustering techniques that often assume clusters are relatively spherical or uniformly shaped (e.g., k-means), density-based clustering may not rely on these geometric assumptions. Instead, density-based clustering techniques may group data point into clusters based on the density distribution of the underlying data, allowing for more natural cluster formations that follow the patterns and structures of the dataset, regardless of geometric form.

Determining the number of clusters (i.e., K for k-means, or a tree cut for hierarchical clustering) may involve employing one or more heuristic methods. For instance, the system 100 may compute silhouette scores. Silhouette scores may refer to metrics that measure how similar each embedding is to the cluster it is assigned to compared to other clusters. A high silhouette score may indicate a better-defined and more cohesive cluster, while a low score may indicate that an embedding may fit better in another cluster or that the chosen number of clusters is not idea. By employing such heuristics, the system 100 can balance course topics with fine topics to generate resulting clusters 118 that are both meaningful and practical for subsequent question generation and evaluation tasks.

The clustering process may implement a measurement of semantic similarity between embeddings. Since each embedding vector 112 encodes the semantic characteristics of a particular chunk of text, vector-based similarity metrics can be used for comparison purposes. For example, cosine similarity, which measures the cosine of the angle between two embedding vectors, may be used because it tends to be insensitive to the magnitude of the vectors and instead focuses more on their directional alignment. Alternatively, Euclidean distance, Manhattan distance, or other vector distance measures may be employed.

While clusters 118 generally form coherent topic-based groups, not all embeddings will fit neatly into one of these clusters. Some embeddings may represent unique content that does not align closely with any established topic. To address this issue, the system 100 may employ one or more strategies for handling outliers for uncertain cluster assignments. For instance, the system 100 may automatically assign an outlier embedding to a cluster having a centroid that is most similar to that embedding, when the similarity meets or exceeds a threshold. If no cluster meets this similarity threshold, the system 100 may form a separate “miscellaneous” cluster dedicated to holding outlier embeddings. Accordingly, all content can be accounted for, even if some embeddings represent topics or styles not prevalent to have a dedicated topic.

Once the clusters 118 are formed, the system 100 may select representative cluster samples 120 from each cluster 118. As an example, a cluster sample (e.g., reference number 120A) may represent detailed product specifications such as input voltage requirements (“Input voltage: 110-240V”). The cluster samples 120 may provide a starting point for question generation and subsequent creation of an evaluation dataset. The selection of these cluster samples 120 can be based on one or more sampling strategies, where each sampling strategy may emphasize different aspects related to topic coverage. Sampling strategies may include simple random sampling, frequency-based weighting, or diversity-driven selection methods that consider both the coverage of common topics and the representation of niche content. By ensuring that cluster samples 120 are drawn from each cluster 118, the system 100 can provide balanced coverage across multiple thematic areas found within the documents 104.

In a basic approach, the system 100 may apply a simple random sampling (SRS) method. Under SRS, the system 100 may select a subset of chunks from each cluster 118 without imposing additional constraints, thereby providing a baseline level of representative coverage. While SRS is easy to implement and computationally efficient, it may inadvertently overemphasize more common topics within a single cluster if a majority of chunks are directed toward a specific topic.

To better reflect the natural distribution of topics in the underlying document collection, frequency-based weighting methods can be employed. In a frequency-based weighted approach, chunks originating from frequently occurring topics or concepts may be assigned a higher probability of selection. This ensures that well-represented themes in the documents are proportionally reflected in the evaluation dataset. At the same time, the system 100 can maintain coverage of less common topics by ensuring their selection probability is not reduced to zero. For example, in a scenario where one cluster in the document collection primarily covers common product setup instructions, and another cluster contains only a few documents discussing rare troubleshooting steps, without any adjustment, a frequency-based sampling method might overwhelmingly select samples from the common setup cluster, and mostly ignore the rare troubleshooting documents. To address this, the system 100 can impose a rule that prevents the selection probability for any cluster—no matter how infrequent its topic—from dropping below a certain minimum threshold, such as 1%. This ensures that even the rare troubleshooting documents retain a small but non-zero chance of being sampled. As a result, a final evaluation dataset includes not only the popular setup instructions but also the less common troubleshooting material, providing a more comprehensive view of the document collection.

As another example, a stratified sampling approach may be used to further refine the representative selection by explicitly controlling how many samples are drawn from each cluster. For instance, if the total desired evaluation dataset size is N and the number of clusters is k, the system 100 may select approximately N/k samples from each cluster. A stratified sampling approach may ensure that each semantic grouping contributes equally to the final dataset, regardless of cluster size.

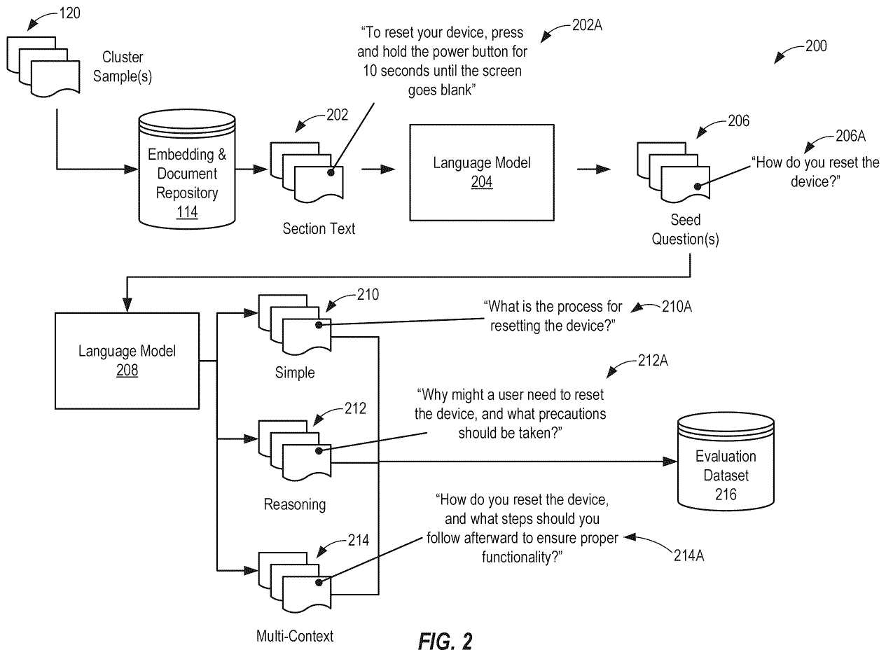

As will be described with respect to FIG. 2, downstream processes may use these selected samples to generate different types of questions (e.g., simple, reasoning-based, or multi-context questions), create ground-truth labels, and measure the retrieval performance of retrieval-augmented generation systems. The structured approach to chunking documents, clustering, and sampling as illustrated in FIG. 1 provides evaluation datasets that are both topically comprehensive and diverse, to better reflect the wide range of content found within the underlying documents 104.

### Example System for Generating an Evaluation Dataset

FIG. 2 depicts an example data processing pipeline 200 for generating a set of evaluation questions from the representative cluster samples 120 in accordance with aspects of the present disclosure. More specifically, FIG. 2 depicts how selected chunks of text (e.g., “section text” 202) may be transformed into a variety of questions with differing levels of complexity and scope, to form part of an evaluation dataset 216. As shown in FIG. 2, the data processing pipeline 200 may begin with one or more cluster samples 120 previously selected from clusters of semantically related document embeddings as described in FIG. 1. These cluster samples 120 represent portions of documents that have been embedded, clustered, and sampled for evaluation. Each cluster sample 120 may correspond to a particular topical segment of the document collection. For example, a cluster sample 120 might relate to a set of instructions for resetting a device, configuring a product feature, or performing a maintenance procedure.

In some aspects, the cluster samples 120 may be used to retrieve corresponding source text from the embedding and document repository 114. From these retrieved segments, the data processing pipeline 200 accesses a “section text” 202 that provides the raw, human-readable content (e.g., “To reset your device, press and hold the power button for 10 seconds until the screen goes blank” 202A). This section text 202, which may include instructions, specifications, definitions, or other domain-relevant information, can be used to generate questions that evaluate a retrieval-augmented generation (RAG) system's performance.

Once the section text 202 is obtained, the data processing pipeline 200 may use a first language model 204 to produce one or more initial “seed questions” 206. The first language model may be a transformer-based model (e.g., a pre-trained large language model, such as BERT or GPT), a recurrent neural network (RNN), or another suitable natural language processing architecture. The specific training and configuration details—such as the selection of pre-training datasets, fine-tuning procedures, and hyperparameters—may vary depending on implementation requirements. In some examples, a model architecture known for capturing semantic relationships and performing domain-specific fine-tuning on a relevant datasets may be selected. Such customization helps ensure that the first language model 204 generates seed questions aligned with the underlying documents. That is, the seed questions 206 may be designed to be closely aligned with the actual content of the section text 202. Accordingly, the seed question may rely on text extraction or a simple restatement of the provided information provided from the first language model 204. For instance, a seed question 206A derived from the exemplary section text 202A might simply ask: “How do you reset the device?” The purpose of the seed questions 206 is to establish a baseline set of straightforward queries that are strictly based on the source material, such that at least a portion of the evaluation dataset aligns closely with the exact wording and factual content of the underlying text.

After generating the seed questions 206, a second language model 208 receives these initial queries and transforms them into multiple tiers (e.g., categories) of queries reflecting differing complexities and reasoning. In some aspects, the second language model 208 may be implemented using a neural network-based architecture configured to transform seed questions into more complex, reasoning-based, or multi-contextual queries. The second language model 208 can leverage similar underlying technologies as the first language model 204, including transformer-based models or recurrent neural networks, but may be trained and/or fine-tuned with a focus on question complexity and richness of content. For instance, while the first language model 204 may specialize in generating straightforward, fact-based seed questions, the second language model 208 could be tuned to incorporate inference steps, conditional logic, or cross-referencing information from multiple document segments. In some implementations, prompt engineering strategies guide the second language model 208, instructing the second language model 208 to produce variations of each seed question at increasing levels of complexity.

As depicted in FIG. 2, the second language model 208 may produce a set of transformed questions at varying complexity levels. For example, a simple question 210 may paraphrase the seed question at a minimal complexity, e.g., “What is the process for resetting the device?” (210A). This level of questioning remains close to the original content but may require the RAG system to confirm the correct procedure or step-by-step actions.

More advanced question types may use reasoning to obtain a question. A “reasoning” question 212 might ask, for example: “Why might a user need to reset the device, and what precautions should be taken?” (212A). Such a reasoning question would prompt a RAG system under evaluation to connect information from the section text 202 to underlying rationales, conditions, or constraints, providing a way to assess the RAG system under evaluation's ability to handle more complex queries.

In addition, a multi-context question 214 may require using information from multiple segments or topically related documents. For instance, a multi-context question 214A could ask: “How do you reset the device, and what steps should you follow afterward to ensure proper functionality?” While still based on the source content, such a query could test the ability of the RAG system under evaluation to aggregate and synthesize different pieces of information, possibly drawn from various chunks within the same cluster or across multiple documents 104 (FIG. 1). Accordingly, the evaluation dataset 216 may not be limited to simple factual retrieval but may also include challenging queries that represent more realistic user inquiries.

In some aspects, prompt engineering techniques may be used to generate the transformed questions based on a desired complexity level or reasoning dimension. For example, to generate simple questions 210, the second language model 208 might be instructed to produce queries that restate or slightly rephrase the seed question in a direct manner. Such an instruction could be: “Rephrase the seed question in a way that remains factual and directly answerable from the text.” This results in simple queries like: “What is the device's required input voltage?” or “What is the process for resetting the device?” (210A). For reasoning questions 212, the data processing pipeline 200 may direct the second language model 208 to incorporate causal or conditional factors that are not explicitly stated in the source text but can be inferred. For example, the prompt provided to the second language model 208 might say: “Transform the seed question into one that requires inference or explanation.” This could provide queries such as: “Why might a user need to reset the device before applying a firmware update?” (212A). Such questions require the downstream system to draw connections or justify procedures rather than just extracting details verbatim. To produce multi-context questions 214, the second language model 208 may be instructed to blend information from multiple chunks, documents, or related topics. The prompt might specify: “Formulate a question that combines instructions from this text segment with details from a related segment (e.g., a maintenance guideline) to produce a single integrated query.” The result could be a query like: “How do you reset the device, and what are the recommended steps afterward to ensure proper operation?” (214A). This type of question may test whether the RAG system under evaluation can assemble and synthesize information scattered across different parts of the document collection.

The generated question variants (e.g., simple, reasoning, and multi-contextual) may be collected into an evaluation dataset 216, along with their corresponding ground truth answers or reference segments. By preparing the varied set of questions, the evaluation dataset 216 can provide a benchmark against which RAG models can be measured. The evaluation dataset, combined with performance metrics, provides users the ability to evaluate retrieval parameters, compare different embedding strategies, and fine-tune RAG system configurations for improved accuracy and resilience to complex queries.

Prior to, or following, the association of ground truth answers with transformed evaluation questions, the data processing pipeline 200 may incorporate a variety of metrics designed to assess retrieval performance. For example, basic measures such as recall (e.g., the fraction of all relevant items that are successfully retired) and precision (e.g., the fraction of retrieved items that are actually relevant) provide initial insights into how effectively a RAG system identifies and returns relevant content, other evaluation approaches can provide a deeper understanding of system capabilities.

For instance, the data processing pipeline 200 may employ semantic similarity scores that measure the closeness of retrieved results to ground truth answers at an embedding level. Using vector-based similarity metrics (e.g., cosine similarity) allows the data processing pipeline 200 to compare candidate responses and target text. Other ranking-based measures, including but not limited to Mean Reciprocal Rank (MRR) or Normalized Discounted Cumulative Gain (nDCG) may be used to evaluate not just whether relevant chunks are retrieved, but also their position in the ranked output list.

### Example Evaluation Dataset

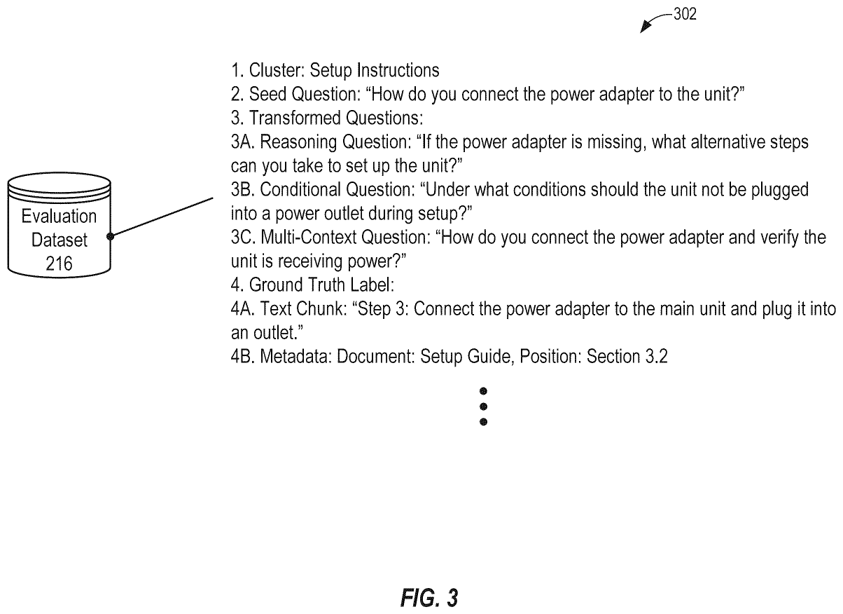

FIG. 3 depicts an example configuration 302 of data entries within an evaluation dataset 216 generated in accordance with the processes described in FIGS. 1 and 2. In some aspects, each data entry may correspond to a cluster of semantically related document segments and may include not only the original “seed question” derived from the source material, but also various transformed question types, associated ground truth answers, and accompanying metadata.

As depicted in FIG. 3, the evaluation dataset 216 may include one or more entries representing distinct clusters of topically similar content. For example, FIG. 3 depicts a cluster labeled “Setup Instructions,” reflecting a subset of document chunks identified through the clustering and sampling techniques previously discussed. Each cluster's entry within the evaluation dataset 216 may include a structured arrangement of information, including a cluster label, seed question, one or more transformed questions, ground truth label, and metadata.

The cluster may be identified by a topic-related descriptor, such as “Setup Instructions,” indicating that the subsequent queries and answers pertain to procedures necessary for initial installation, configuration, or assembly of a particular device or system. The cluster label may be automatically derived from the clustering algorithm's analysis of semantic embeddings or provided by subject matter experts familiar with the topic. The “seed question” may be initially generated from the underlying text segments within the cluster. For example, the seed question “How do you connect the power adapter to the unit?” directly addresses a fundamental step referenced in the source documentation. Seed questions serve as the baseline query that closely reflects the factual content of the underlying text.

The transformed questions may include several questions that represent increasingly sophisticated or contextually enriched variations of the seed question. For instance, Reasoning Question (3A) may be: “If the power adapter is missing, what alternative steps can you take to set up the unit?” This query introduces a scenario requiring the system to reason about conditions not explicitly described in the base text. The Conditional Question (3B) may be: “Under what conditions should the unit not be plugged into a power outlet during setup?” The Conditional Question adds conditional logic, which may prompt a system to consider safety measures, prerequisites, or exceptions inferred from the provided instructions. The Multi-Context Question (3C) may be: “How do you connect the power adapter and verify the unit is receiving power?” This multi-context variation may require that a system use multiple pieces of information, potentially drawn from different parts of the corpus, to produce a coherent and complete response. By including reasoning, conditional, and multi-context questions, the evaluation dataset 216 can be used to test a RAG system's ability to handle complexity, rather than merely extracting obvious facts from a single text segment.

Each cluster entry may also include a ground truth label that indicates the ideal, authoritative answer or text segment associated with the questions. In the example illustrated in FIG. 3, the ground truth label (4A) reads: “Step 3: Connect the power adapter to the main unit and plug it into an outlet.” This ground truth segment may be taken directly from the original source content and may be considered the authoritative answer against which retrieved passages and generated responses are to be evaluated. As an example, ground truth labels can be stored in the evaluation dataset 216 and compared to retrieved passages or generated responses through one or more evaluation processes. For instance, the system may embed both the retrieved passages and the ground truth label as vector embeddings and compute similarity scores (e.g., cosine similarity) or apply ranking metrics (e.g., MRR, nDCG) to determine how closely the retrieved or generated text aligns semantically with the ground truth. By implementing these embedding comparisons, scoring techniques, and ranking strategies, the ground truth label serves as an authoritative benchmark against which system performance can be quantitatively assessed.

Alongside the ground truth label, metadata may provide contextual details regarding the origin and location of the underlying text. For example, the metadata may include references to a “Setup Guide,” section numbers, timestamps, document identifiers, or version control information. By preserving such metadata, the evaluation dataset 216 can provide traceability and enable developers, system evaluators, or auditors to verify the correctness and appropriateness of the ground truth references.

### Example Retrieval System Evaluation

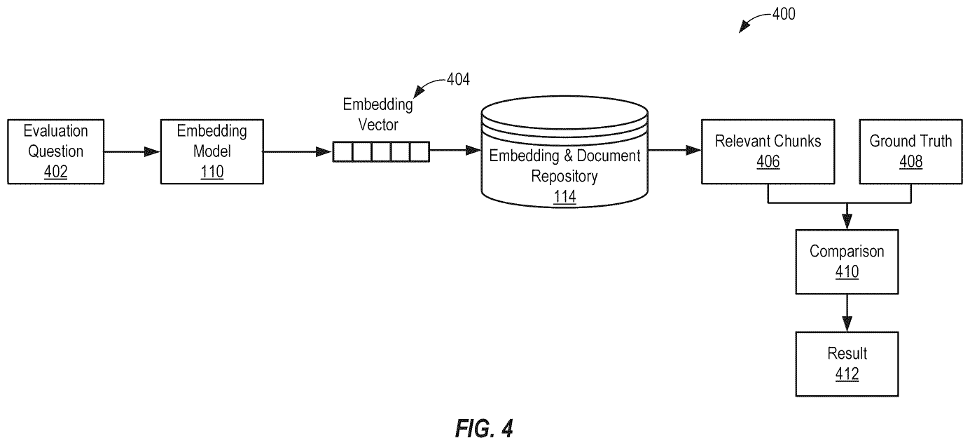

FIG. 4 depicts an example retrieval evaluation pipeline 400 configured to assess the performance of a RAG system using the evaluation datasets described with respect to FIGS. 1-3. More specifically, FIG. 4 depicts how an evaluation question 402, drawn from an evaluation dataset containing both seed and transformed questions, is processed and compared against ground truth answers to yield quantifiable performance metrics.

As shown in FIG. 4, the example retrieval evaluation pipeline 400 starts with an evaluation question 402. This question may be a simple, reasoning-based, conditional, or multi-context inquiry previously generated as part of the evaluation dataset. In certain implementations, the evaluation question 402 corresponds to a query specifically crafted to investigate different capabilities of the underlying retrieval system - such as extracting key factual information, handling scenario-based reasoning, or synthesizing content from multiple sources.

The evaluation question 402 is provided as input to an embedding model 110. The embedding model 110 generates a corresponding embedding vector 404 that represents the semantic features of the question. The embedding vector 404 captures the conceptual meaning underlying the query rather than relying solely on keyword overlap.

Next, the embedding vector 404 may be used to query the embedding and document repository 114. As previously described, the embedding and document repository 114 stores both document chunks and their associated embeddings. By performing a similarity search using the embedding vector 404 derived from the evaluation question 402, the RAG system identifies one or more relevant chunks 406 from the embedding and document repository 114. In comparison to conventional keyword-based or brute-force search methods, vector-based similarity searches can be faster and more computationally efficient while still capturing semantic relationships. The retrieved relevant chunks 406 are those that best align semantically with the posed query, as determined by vector similarity metrics such as cosine similarity or Euclidean distance. Depending on the configuration, additional retrieval techniques—such as filtering, ranking, or re-ranking—may be employed to ensure that the most pertinent results appear at the top. By comparing the content of the retrieved results corresponding to the relevant chunks 406 to the ground truth 408, the system can determine how closely the retrieval operation approximates an ideal, known-correct response.

Such a comparison may occur at stage 410. Various evaluation metrics may be applied at stage 410. For example, recall and precision can indicate how many correct segments were found and how many retrieved segments were relevant, respectively. Ranking-based metrics (e.g., MRR, nDCG) may measure whether the correct answers are found at top positions. Additionally, semantic similarity metrics (e.g., BERTScore, cosine similarity of embeddings) or reference-based metrics (e.g., ROUGE, BLEU) may be employed to gauge the closeness in meaning between the retrieved chunks and the ground truth answers. For example, consider a ground truth answer stating, “The product requires an input voltage of 110-240V.” If the example retrieval evaluation pipeline 400 retrieves three segments, two of which accurately mention the input voltage range and one that discusses unrelated maintenance steps, precision might be ⅔ (e.g., two out of three returned segments are relevant), and if all relevant voltage-related segments were found, recall could be 2/2 (e.g., all relevant segments retrieved). For ranking-based metrics, if the correct voltage requirement is retrieved as the top-ranked result, the MRR might be 1.0, and nDCG would similarly reflect a high-quality ranking. Additionally, semantic similarity metrics—such as BERTScore or cosine similarity—could yield values close to 1.0 for a near-identical match (e.g., “Input voltage: 110-240V” vs. “The product requires an input voltage of 110-240V”). In the case of more complex, reasoning-oriented, or multi-context queries, specialized metrics could assess logical coherence, inference correctness, or the completeness of aggregated information.

Upon completion of the comparison, the retrieval evaluation pipeline 400 generates a result 412, providing a quantitative or qualitative measure of retrieval performance. Quantitative measures might include numerical scores, rankings, or composite metrics combining multiple evaluation criteria, while qualitative measures could involve expert annotations, user feedback, or subjective ratings provided by domain specialists. The result 412 can be expressed as a numerical score, a set of ranks, or a composite metric reflecting multiple aspects of performance. In some aspects, developers may use a low similarity score to initiate a retraining process for the embedding model on a more representative dataset, adjust chunking strategies by altering segment lengths to better capture semantic units, or fine-tune retrieval parameters (e.g., similarity thresholds, re-ranking rules) to emphasize more relevant content. Automated optimization routines may also employ these metrics to iteratively refine the system's configurations—such as experimenting with different embedding models, altering indexing parameters, or adjusting clustering algorithms—thereby enhancing the RAG system's overall accuracy and reliability over time.

### Example Method for Generating an Evaluation Dataset

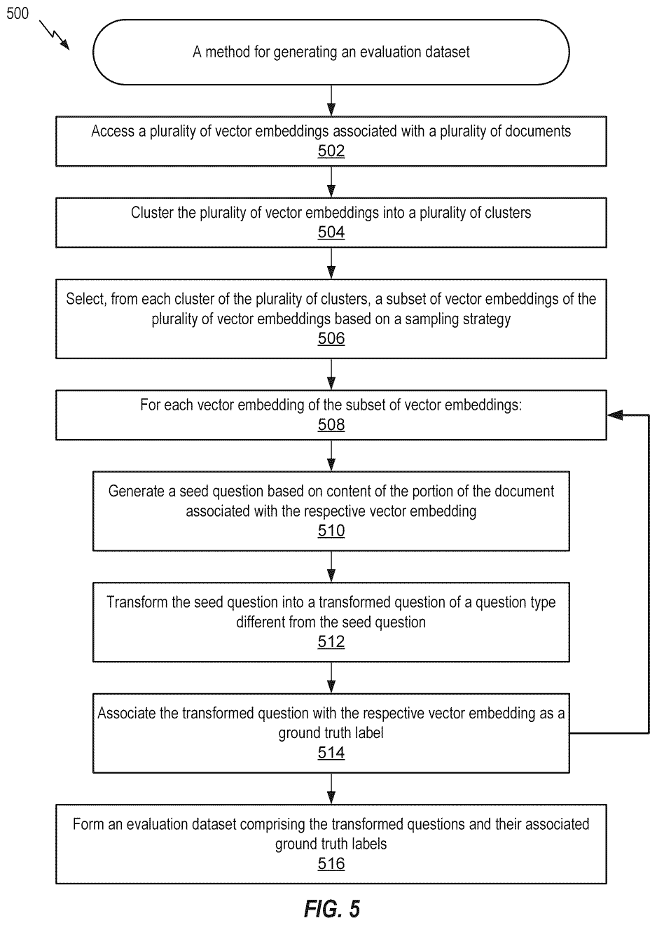

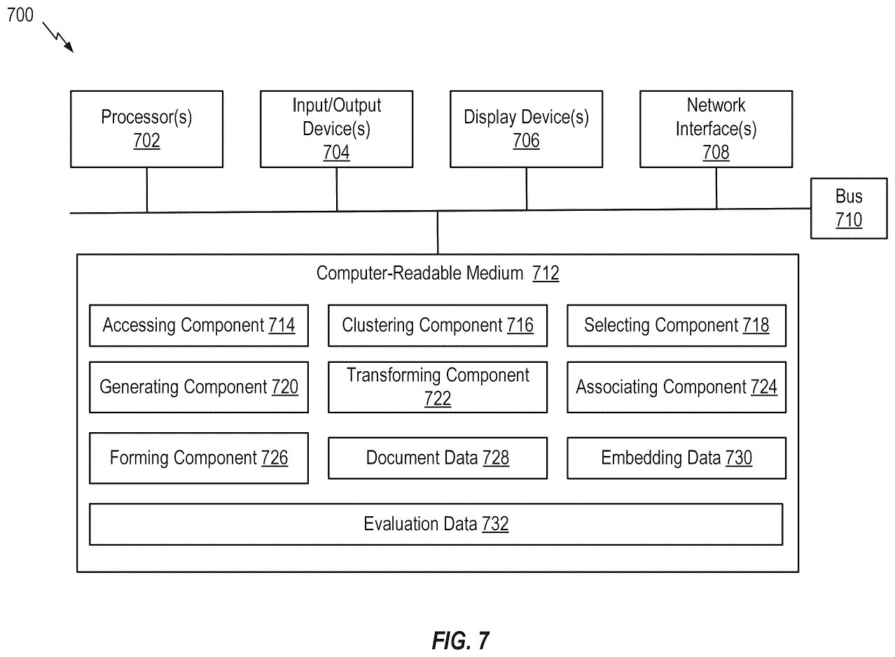

FIG. 5 depicts an example method 500 for generating an evaluation dataset. In one aspect, method 500 can be implemented by the system 100 of FIG. 1 and/or processing system 700 of FIG. 7. Additionally, some steps of method 500 may align with the operations and data processing pipeline illustrated in FIG. 2, such as generating seed questions and transforming them into more complex queries, and can also be integrated or coordinated with the retrieval evaluation pipeline depicted in FIG. 4.

Method 500 starts at block 502 with accessing a plurality of vector embeddings associated with a plurality of documents. In some aspects, each vector embedding of the plurality of vector embeddings corresponds to at least a portion of a document of the plurality of documents. In some aspects, the embedding and document repository (such as embedding and document repository 114 in FIG. 1) may already store document embeddings. These embeddings may have been generated by an embedding model (e.g., embedding model 110) that converts document chunks into vector representations enabling semantic comparisons. By accessing these embeddings, the method begins with a structured data representation suitable for downstream operations.

Method 500 continues to block 504 with clustering the plurality of vector embeddings into a plurality of clusters. As described with respect to FIG. 1, clustering can group embeddings that share semantic similarities. Clustering helps partition the corpus into distinct categories or topics, allowing subsequent steps to select representative and diverse subsets of embeddings.

In some aspects of method 500, clustering the plurality of vector embeddings comprises identifying a representative topic for each cluster based on a common semantic meaning of the vector embeddings within the cluster.

In some aspects of method 500, selecting the subset of vector embeddings of the plurality of vector embeddings comprises identifying vector embeddings of the plurality of vector embeddings based on the identified representative topics.

Method 500 continues to block 506 with selecting, from each cluster of the plurality of clusters, a subset of vector embeddings of the plurality of vector embeddings according to a sampling strategy. In some aspects, the sampling stage referenced in connection with FIGS. 2 and 3, may involve simple random selection or more complex approaches that factor in diversity scores or occurrence frequency. By selecting representative subsets, sampling reduces redundant queries and includes content covering a broad semantic range.

In some aspects of method 500, selecting the subset of vector embeddings comprises selecting N/K vector embeddings from each cluster of the plurality of clusters, and N is an evaluation dataset size and K is a number of clusters.

In some aspects of method 500, selecting the subset of vector embeddings comprises weighting a selection probability based on a frequency of occurrence for content associated with each vector embedding in the plurality of documents.

In some aspects of method 500, selecting the subset of vector embeddings comprises increasing semantic diversity within each cluster of the plurality of clusters by: generating a diversity score for vector embeddings based on pairwise semantic distance; and selecting vector embeddings for the subset of vector embeddings based on the diversity scores.

Method 500 continues to block 508 with, for each respective vector embedding of the subset of vector embeddings performing blocks 510-514.

Method 500 continues to block 510 with generating a seed question based on content of the portion of the document associated with the respective vector embedding. As noted in FIG. 2, seed questions may be derived using language models (e.g., first language model 204) to formulate baseline queries from source text.

In some aspects of method 500, generating the seed question comprises using a first language model, and transforming the seed question into the transformed question comprises using a second language model.

Method 500 continues to block 512 with transforming the seed question into a transformed question of a question type different from the seed question. For example, the seed question may be transformed into a different question type, such as a reasoning or multi-context question, as also illustrated in FIG. 2. By producing various question types, the method 500 can diversify the range of evaluation queries.

In some aspects of method 500, transforming the seed question into the transformed question comprises increasing a complexity level of the seed question by including reasoning across multiple portions of a document of the plurality of documents associated with the respective vector embedding of the subset of vector embeddings.

Method 500 continues to block 514 with associating the transformed question with the respective vector embedding as a ground truth label. That the transformed questions are associated with their respective vector embeddings along with corresponding ground truth labels (e.g., text chunks and metadata as shown in FIG. 3).

Method 500 continues to block 516 with forming an evaluation dataset comprising the transformed questions and their associated ground truth labels. That is, the method 500 may form an evaluation dataset comprising the transformed questions and their associated ground truth labels. This dataset, when employed as described in FIG. 4, can be used to measure and compare retrieval performance.

In some aspects of method 500, the question type comprises a multi-context question.

In some aspects, method 500 further includes determining whether new documents have been added to the plurality of documents; selecting additional vector embeddings for the new documents according to the sampling strategy; and updating the evaluation dataset with additional transformed questions generated from the additional vector embeddings.

In some aspects, method 500 further includes generating comparative performance metrics for different configurations of a retrieval-augmented generation (RAG) system tested using the evaluation dataset; and adjusting one or more retrieval configurations of the RAG system based on the comparative performance metrics.

In some aspects of method 500, the comparative performance metrics comprise at least one of: recall; precision; or a retrieval match score indicating a percentage of retrieved document portions that match ground truth labels.

In some aspects of method 500, adjusting the one or more retrieval configurations of the RAG system based on the comparative performance metrics includes modifying at least one of: a chunking configuration used to segment each document of the plurality of documents; or one or more parameters of an embedding model used to generate the plurality of vector embeddings.

Method 500 provides several beneficial technical effects. By leveraging semantic embeddings and clustering, the method 500 can generate evaluation data that spans a range of document topics without overly focusing on common or frequently occurring content. Such an approach may reduce manual effort, as the questions and labels can be generated programmatically. In some examples, such an approach may enhances scalability by working on only a subset of clustered embeddings rather than the entire corpus. Additionally, the introduction of various question types (e.g., simple, reasoning, multi-context) provides a greater evaluation environment by evaluating specific strengths and weaknesses in RAG systems.

FIG. 5 and method 500 are only one example. Other methods may include fewer, additional, or alternative operations. For instance, certain implementations might integrate multiple clustering algorithms, incorporate domain-specific metadata, or apply different language models to produce specialized question types. Each variation remains consistent with the spirit of this disclosure, which focuses on the generation of robust, high-quality evaluation datasets suitable for advanced retrieval systems.

### Example Method for Evaluating and Refining Operational Parameters of an Information Retrieval System

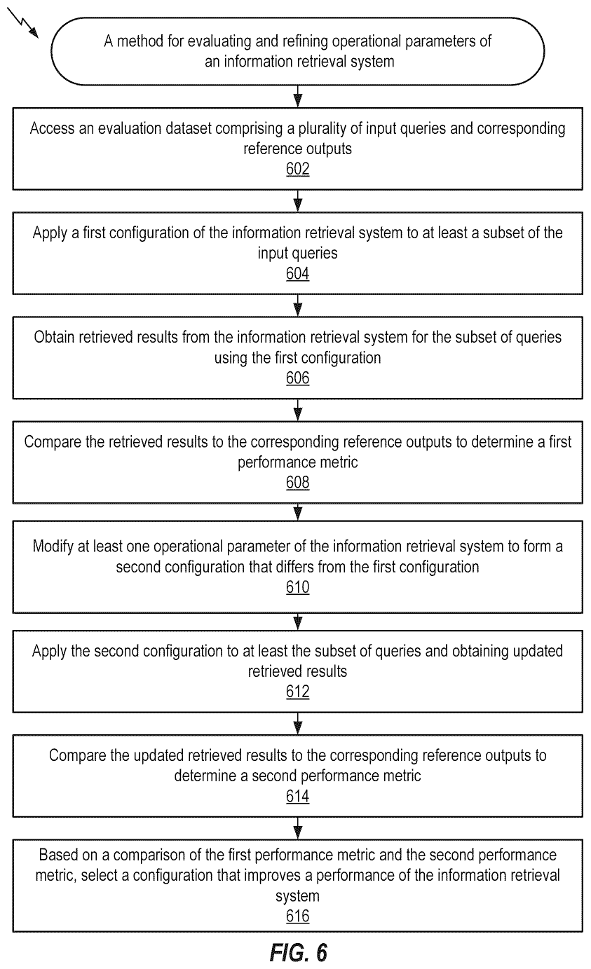

FIG. 6 depicts an example method 600 for evaluating and refining operational parameters of an information retrieval system, in accordance with aspects of the present disclosure.

Method 600 beings at block 602, with accessing an evaluation dataset comprising a plurality of input queries and corresponding reference outputs. In some aspects, the evaluation dataset may be generated and structured as described previously with respect to FIGS. 1, 2, 3, and 5.

In some aspects of method 600, the evaluation dataset may be generated by: accessing a plurality of vector embeddings associated with a plurality of documents, wherein each vector embedding of the plurality of vector embeddings corresponds to at least a portion of a document of the plurality of documents; clustering the plurality of vector embeddings into a plurality of clusters; selecting, from each cluster of the plurality of clusters, a subset of vector embeddings of the plurality of vector embeddings according to a sampling strategy; for each respective vector embedding of the subset of vector embeddings: generating a seed question based on content of the portion of the document associated with the respective vector embedding; transforming the seed question into a transformed question of a question type different from the seed question; and associating the transformed question with the respective vector embedding as a ground truth label; and forming an evaluation dataset comprising the transformed questions and their associated ground truth labels.

Method 600 continues to block 604 with applying a first configuration of the information retrieval system to at least a subset of the input queries, the first configuration specifying at least one operational parameter for locating and providing information in response to the input queries. In some aspects, a “configuration” may specify one or more operational parameters of the retrieval system, such as ranking algorithms, indexing strategies, embedding models, query expansion settings, or retrieval filter criteria. By executing these queries with a known configuration, initial performance characteristics of the system can be established.

Method 600 continues to block 606 with obtaining retrieved results from the information retrieval system for the subset of queries using the first configuration. In some aspects, a vector-based similarity search may be used, applying retrieval heuristics, or executing other techniques as previously described, to generate system responses for each query in the subset.

Method 600 continues to block 608 with comparing the retrieved results to the corresponding reference outputs to determine a first performance metric. In some aspects, this comparison may be performed using various evaluation measures, such as precision, recall, F-scores, ranking-based metrics (e.g., MRR, nDCG), semantic similarity metrics, or other domain-specific criteria. By quantifying how closely the retrieved results match the reference outputs, the first performance metric can provide a baseline indication of system effectiveness under the initial configuration.

Method 600 continues to block 610 with modifying at least one operational parameter of the information retrieval system to form a second configuration that differs from the first configuration. For instance, the system may adjust chunking strategies, alter embedding model parameters, apply different retrieval filters, or incorporate additional indexing techniques. The selection of which parameter to modify may be guided by the previously computed performance metric, expert input, automated optimization routines, or other criteria.

Method 600 continues to block 612 with applying the second configuration to at least the subset of queries and obtaining updated retrieved results. For example, the retrieval system may be tested again under a new operational setup, generating a second set of results that may differ from those produced under the first configuration.

Method 600 continues to block 614 with comparing the updated retrieved results to the corresponding reference outputs to determine a second performance metric. Using the same or similar evaluation measures as used in block 608 ensures that changes in system performance can be attributed to modifications in the operational parameters.

Method 600 continues to block 616 with based on a comparison of the first performance metric and the second performance metric, selecting a configuration that improves a performance of the information retrieval system. For example, if the second configuration yields better recall and precision scores than the first configure, the system may adopt the adjusted parameters. Conversely, if performance degrades, alternative adjustments can be attempted.

In some aspects of method 600, the at least one operational parameter comprises a parameter comprising at least one of: a ranking algorithm parameter, an indexing strategy, a query expansion setting, an embedding model parameter, or a retrieval filter criterion.

In some aspects of method 600, the performance metrics used to compare the updated retrieved results against the corresponding reference outputs comprises at least one of precision, recall, an F-score, a relevance score, or a semantic similarity measure.

Method 600 provides several beneficial technical effects. By evaluating and refining operational parameters of the information retrieval system, method 600 can guide improvements without relying solely on trial-and-error or manual tuning. Such an approach may reduce time and resource use, as adjustments to retrieval parameters can be made based on quantifiable performance metrics. In some examples, the method 600 enhances adaptability by enabling the system to respond dynamically to changing data domains or evolving user needs. Additionally, the integration of different parameter types (e.g., indexing strategies, embedding models, query expansion settings) ensures that the evaluation process addresses multiple aspects of retrieval system performance.

FIG. 6 and method 600 are only one example. Other methods may include fewer, additional, or alternative steps. For instance, certain implementations may incorporate specialized tuning protocols, integrate external knowledge bases for informed parameter selection, or apply machine-learning models to predict optimal parameter configurations. Each variation remains consistent with the spirit of this disclosure, which focuses on improving retrieval system effectiveness through structured evaluation and refinement techniques.

FIG. 6 provides several beneficial technical effects. By integrating modular hardware components and scalable data channels, FIG. 6 can facilitate faster computation, more efficient data transfer, and enhanced resilience against system bottlenecks. Such an architecture may reduce operational overhead, as monitoring and maintenance tasks can be simplified through centralized control interfaces. In some examples, the framework illustrated in FIG. 6 may enhance adaptability by allowing selective deployment of specialized accelerators instead of overhauling the entire system. Additionally, the standardized interconnects and interfaces depicted foster a robust environment for iterative refinements, thereby improving the overall quality and extensibility of advanced data processing infrastructures.

### Example Processing System for Generating an Evaluation Dataset

FIG. 7 depicts an example processing system 700 configured to perform various aspects described herein, including, for example, method 500 as described above with respect to FIG. 7.

Processing system 700 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 700 includes one or more processors 702, one or more input/output devices 704, one or more display devices 706, one or more network interfaces 708 through which processing system 700 is connected to one or more networks (e.g., a local network, an intranet, the Internet, or any other group of processing systems communicatively connected to each other), and computer-readable medium 712. In the depicted example, the aforementioned components are coupled by a bus 710, which may generally be configured for data exchange amongst the components. Bus 710 may be representative of multiple buses, while only one is depicted for simplicity.

Processor(s) 702 are generally configured to retrieve and execute instructions stored in one or more memories, including local memories like computer-readable medium 712, as well as remote memories and data stores. Similarly, processor(s) 702 are configured to store application data residing in local memories like the computer-readable medium 712, as well as remote memories and data stores. More generally, bus 710 is configured to transmit programming instructions and application data among the processor(s) 702, display device(s) 706, network interface(s) 708, and/or computer-readable medium 712. In certain embodiments, processor(s) 702 are representative of a one or more central processing units (CPUs), graphics processing unit (GPUs), tensor processing unit (TPUs), accelerators, and other processing devices.

Input/output device(s) 704 may include any device, mechanism, system, interactive display, and/or various other hardware and software components for communicating information between processing system 700 and a user of processing system 700. For example, input/output device(s) 704 may include input hardware, such as a keyboard, touch screen, button, microphone, speaker, and/or other device for receiving inputs from the user and sending outputs to the user.

Display device(s) 706 may generally include any sort of device configured to display data, information, graphics, user interface elements, and the like to a user. For example, display device(s) 706 may include internal and external displays such as an internal display of a tablet computer or an external display for a server computer or a projector. Display device(s) 706 may further include displays for devices, such as augmented, virtual, and/or extended reality devices. In various embodiments, display device(s) 706 may be configured to display a graphical user interface.

Network interface(s) 708 provide processing system 700 with access to external networks and thereby to external processing systems. Network interface(s) 708 can generally be any hardware and/or software capable of transmitting and/or receiving data via a wired or wireless network connection. Accordingly, network interface(s) 708 can include a communication transceiver for sending and/or receiving any wired and/or wireless communication.

Computer-readable medium 712 may be a volatile memory, such as a random access memory (RAM), or a nonvolatile memory, such as nonvolatile random access memory (NVRAM), or the like. In this example, computer-readable medium 712 includes instructions and data structures that correspond to various functional components, such as an accessing component 714, a clustering component 716, a selecting component 718, a generating component 720, a transforming component 722, an associating component 724, and a forming component 726. In addition, the computer-readable medium 712 may store document data 728, embedding data 730, and evaluation dataset 732. These components and data structures collectively provide the logic and information needed to perform the methods described herein, including the steps outlined in FIG. 5 and the underlying processes illustrated in FIGS. 1-4.

In certain embodiments, one or more of the aforementioned components may be configured to execute specific tasks that produce the technical effects described above. For example, the clustering component 716 may apply clustering algorithms to embedding data 730 to identify semantically related groups of content, while the selecting component 718 chooses representative samples from these clusters. The generating component 720 may create seed questions from document data 728, and the transforming component 722 may convert these seed questions into more complex queries, contributing to a more effective evaluation dataset 732. By enabling these operations through automated instructions stored in computer-readable medium 712, the processing system 700 can provide a scalable and efficient technical solution to challenges in evaluating retrieval-augmented generation systems.

Note that FIG. 7 is just one example of a processing system consistent with aspects described herein, and other processing systems having additional, alternative, or fewer components are possible consistent.

### Example Processing System for Evaluating and Refining Operational Parameters of an Information Retrieval System

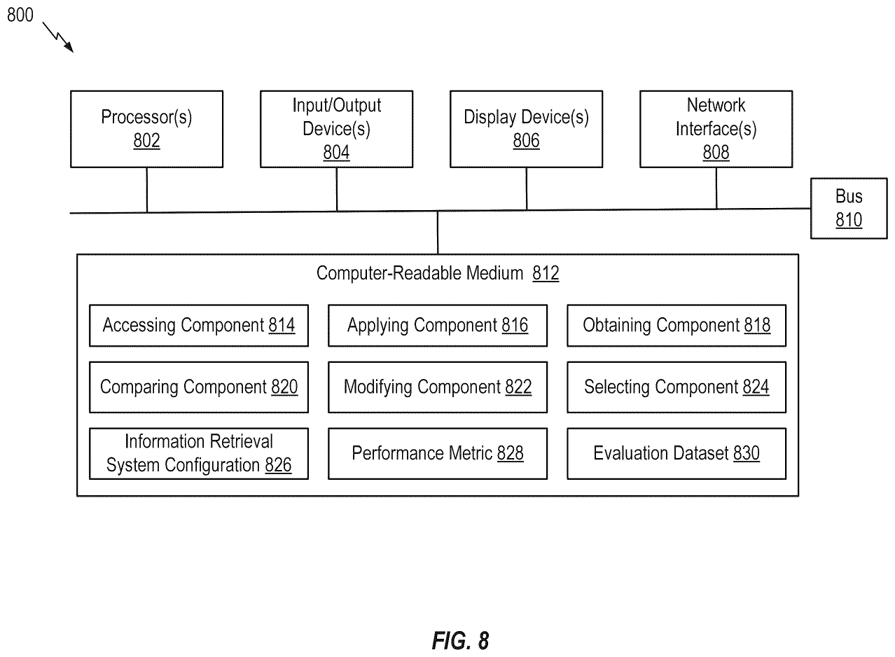

FIG. 8 depicts an example processing system 800 configured to perform various aspects described herein, including, for example, method 600 as described above with respect to FIG. 6.

Processing system 800 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 800 includes one or more processors 802, one or more input/output devices 804, one or more display devices 806, one or more network interfaces 808 through which processing system 800 is connected to one or more networks (e.g., a local network, an intranet, the Internet, or any other group of processing systems communicatively connected to each other), and computer-readable medium 812. In the depicted example, the aforementioned components are coupled by a bus 810, which may generally be configured for data exchange amongst the components. Bus 810 may be representative of multiple buses, while only one is depicted for simplicity.

Processor(s) 802 are generally configured to retrieve and execute instructions stored in one or more memories, including local memories like computer-readable medium 812, as well as remote memories and data stores. Similarly, processor(s) 802 are configured to store application data residing in local memories like the computer-readable medium 812, as well as remote memories and data stores. More generally, bus 810 is configured to transmit programming instructions and application data among the processor(s) 802, display device(s) 806, network interface(s) 808, and/or computer-readable medium 812. In certain embodiments, processor(s) 802 are representative of a one or more central processing units (CPUs), graphics processing unit (GPUs), tensor processing unit (TPUs), accelerators, and other processing devices.

Input/output device(s) 804 may include any device, mechanism, system, interactive display, and/or various other hardware and software components for communicating information between processing system 800 and a user of processing system 800. For example, input/output device(s) 804 may include input hardware, such as a keyboard, touch screen, button, microphone, speaker, and/or other device for receiving inputs from the user and sending outputs to the user.

Display device(s) 806 may generally include any sort of device configured to display data, information, graphics, user interface elements, and the like to a user. For example, display device(s) 806 may include internal and external displays such as an internal display of a tablet computer or an external display for a server computer or a projector. Display device(s) 806 may further include displays for devices, such as augmented, virtual, and/or extended reality devices. In various embodiments, display device(s) 806 may be configured to display a graphical user interface.

Network interface(s) 808 provide processing system 800 with access to external networks and thereby to external processing systems. Network interface(s) 808 can generally be any hardware and/or software capable of transmitting and/or receiving data via a wired or wireless network connection. Accordingly, network interface(s) 808 can include a communication transceiver for sending and/or receiving any wired and/or wireless communication.

In certain aspects, the computer-readable medium 812 may store an accessing component 814 configured to access an evaluation dataset (e.g., as discussed at block 602 of FIG. 6) comprising a plurality of input queries and corresponding reference outputs. The applying component 816 may apply a first configuration of an information retrieval system to at least a subset of the queries (e.g., as at block 604), while the obtaining component 818 retrieves results for those queries (block 606). A comparing component 820 may compare these retrieved results to the reference outputs to determine a first performance metric (block 608).

To refine the system's operation, the processing system 800 may include a modifying component 822 to adjust one or more operational parameters of the information retrieval system, forming a second configuration that differs from the first configuration (block 610). A selecting component 824 may then apply the second configuration to the queries and obtain updated retrieved results (block 612), with the comparing component 820 again evaluating these results against the reference outputs to produce a second performance metric (block 614).

Based on a comparison of the first and second performance metrics, an information retrieval system configuration 826 may be updated or selected to improve system performance (block 616). The performance metric 828 and evaluation dataset 830, stored in the computer-readable medium 812, provide the metrics and evaluation dataset for guiding iterative refinements. By utilizing these components and data structures, the processing system 800 can systematically evaluate and refine operational parameters, ultimately enhancing the accuracy and reliability of the information retrieval system in accordance with the techniques described herein.

Note that FIG. 8 is just one example of a processing system consistent with aspects described herein, and other processing systems having additional, alternative, or fewer components are possible consistent.

### Example Clauses

Implementation examples are described in the following numbered clauses:

Clause 1: A method for generating an evaluation dataset, the method comprising: accessing a plurality of vector embeddings associated with a plurality of documents, wherein each vector embedding of the plurality of vector embeddings corresponds to at least a portion of a document of the plurality of documents; clustering the plurality of vector embeddings into a plurality of clusters; selecting, from each cluster of the plurality of clusters, a subset of vector embeddings of the plurality of vector embeddings according to a sampling strategy; for each respective vector embedding of the subset of vector embeddings: generating a seed question based on content of the portion of the document associated with the respective vector embedding; transforming the seed question into a transformed question of a question type different from the seed question; and associating the transformed question with the respective vector embedding as a ground truth label; and forming an evaluation dataset comprising the transformed questions and their associated ground truth labels.

Clause 2: The method of Clause 1, wherein selecting the subset of vector embeddings comprises selecting N/K vector embeddings from each cluster of the plurality of clusters, and N is an evaluation dataset size and K is a number of clusters.

Clause 3: The method of any of Clauses 1-2, wherein selecting the subset of vector embeddings comprises weighting a selection probability based on a frequency of occurrence for content associated with each vector embedding in the plurality of documents.

Clause 4: The method of any of Clauses 1-3, wherein selecting the subset of vector embeddings comprises increasing semantic diversity within each cluster of the plurality of clusters by: generating a diversity score for vector embeddings based on pairwise semantic distance; and selecting vector embeddings for the subset of vector embeddings based on the diversity scores.

Clause 5: The method of any of Clauses 1-4, wherein the question type comprises a multi-context question.

Clause 6: The method of any of Clauses 1-5, wherein: generating the seed question comprises using a first language model, and transforming the seed question into the transformed question comprises using a second language model.

Clause 7: The method of any of Clauses 1-6, wherein transforming the seed question into the transformed question comprises increasing a complexity level of the seed question by including reasoning across multiple portions of a document of the plurality of documents associated with the respective vector embedding of the subset of vector embeddings.

Clause 8: The method of any of Clauses 1-7, wherein clustering the plurality of vector embeddings comprises identifying a representative topic for each cluster based on a common semantic meaning of the vector embeddings within the cluster.

Clause 9: The method of Clause 8, wherein selecting the subset of vector embeddings of the plurality of vector embeddings comprises identifying vector embeddings of the plurality of vector embeddings based on the identified representative topics.

Clause 10: The method of any of Clauses 1-8, further comprising: determining whether new documents have been added to the plurality of documents; selecting additional vector embeddings for the new documents according to the sampling strategy; and updating the evaluation dataset with additional transformed questions generated from the additional vector embeddings.

Clause 11: The method of any of Clauses 1-9, further comprising: generating comparative performance metrics for different configurations of a retrieval-augmented generation (RAG) system tested using the evaluation dataset; and adjusting one or more retrieval configurations of the RAG system based on the comparative performance metrics.

Clause 12: The method of Clause 11, wherein the comparative performance metrics comprise at least one of: recall; precision; or a retrieval match score indicating a percentage of retrieved document portions that match ground truth labels.

Clause 13: The method of Clause 11, wherein adjusting the one or more retrieval configurations of the RAG system based on the comparative performance metrics includes modifying at least one of: a chunking configuration used to segment each document of the plurality of documents; or one or more parameters of an embedding model used to generate the plurality of vector embeddings.

Clause 14: A method for evaluating and refining operational parameters of an information retrieval system, the method comprising: accessing an evaluation dataset comprising a plurality of input queries and corresponding reference outputs; applying a first configuration of the information retrieval system to at least a subset of the input queries, the first configuration specifying at least one operational parameter for locating and providing information in response to the input queries; obtaining retrieved results from the information retrieval system for the subset of queries using the first configuration; comparing the retrieved results to the corresponding reference outputs to determine a first performance metric; modifying at least one operational parameter of the information retrieval system to form a second configuration that differs from the first configuration; applying the second configuration to at least the subset of queries and obtaining updated retrieved results; comparing the updated retrieved results to the corresponding reference outputs to determine a second performance metric; and based on a comparison of the first performance metric and the second performance metric, selecting a configuration that improves the performance of the information retrieval system.

Clause 15: The method of Clause 14, wherein the at least one operational parameter comprises at least one of a ranking algorithm parameter, an indexing strategy, a query expansion setting, an embedding model parameter, or a retrieval filter criterion.

Clause 16: The method of any of Clause 14-15, wherein the performance metrics used to compare the retrieved results against the reference outputs includes at least one of precision, recall, an F-score, a relevance score, or a semantic similarity measure.

Clause 17: The method of any of Clause 14-16, further comprising repeating the steps of modifying the operational parameter and comparing subsequent performance metrics until a predetermined performance threshold is achieved or exceeded.

Clause 18: A processing system, comprising: a memory comprising computer-executable instructions; and a processor configured to execute the computer-executable instructions and cause the processing system to perform a method in accordance with any one of Clauses 1-17.

Clause 19: A processing system, comprising means for performing a method in accordance with any one of Clauses 1-17.

Clause 20: A non-transitory computer-readable medium storing program code for causing a processing system to perform the steps of any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, for generating an evaluation dataset, the method comprising:
accessing a plurality of vector embeddings associated with a plurality of documents, wherein each vector embedding of the plurality of vector embeddings corresponds to at least a portion of a document of the plurality of documents;
clustering the plurality of vector embeddings into a plurality of clusters;
selecting, from each cluster of the plurality of clusters, a subset of vector embeddings of the plurality of vector embeddings according to a sampling strategy;
for each respective vector embedding of the subset of vector embeddings:
generating a seed question based on content of the portion of the document associated with the respective vector embedding;
transforming the seed question into a transformed question of a question type different from the seed question; and
associating the transformed question with the respective vector embedding as a ground truth label; and
forming an evaluation dataset comprising the transformed questions and their associated ground truth labels.

2. The method of claim 1, wherein:
selecting the subset of vector embeddings comprises selecting N/K vector embeddings from each cluster of the plurality of clusters, and
N is an evaluation dataset size and K is a number of clusters.

3. The method of claim 1, wherein selecting the subset of vector embeddings comprises weighting a selection probability based on a frequency of occurrence for content associated with each vector embedding in the plurality of documents.

4. The method of claim 1, wherein selecting the subset of vector embeddings comprises increasing semantic diversity within each cluster of the plurality of clusters by:
generating a diversity score for vector embeddings based on pairwise semantic distance; and
selecting vector embeddings for the subset of vector embeddings based on the diversity scores.

5. The method of claim 1, wherein the question type comprises a multi-context question.

6. The method of claim 1, wherein:
generating the seed question comprises using a first anguage model, and
transforming the seed question into the transformed question comprises using a second language model.

7. The method of claim 1, wherein transforming the seed question into the transformed question comprises increasing a complexity level of the seed question by including reasoning across multiple portions of a document of the plurality of documents associated with the respective vector embedding of the subset of vector embeddings.

8. The method of claim 1, further comprising: identifying a representative topic for each cluster based on a common semantic meaning of the vector embeddings within the cluster.

9. The method of claim 8, wherein selecting the subset of vector embeddings of the plurality of vector embeddings comprises identifying vector embeddings of the plurality of vector embeddings based on the identified representative topics.

10. The method of claim 1, further comprising:
determining whether new documents have been added to the plurality of documents;
selecting additional vector embeddings for the new documents according to the sampling strategy; and
updating the evaluation dataset with additional transformed questions generated from the additional vector embeddings.

11. The method of claim 1, further comprising:
generating comparative performance metrics for different configurations of a retrieval-augmented generation (RAG) system tested using the evaluation dataset; and
adjusting one or more retrieval configurations of the RAG system based on the comparative performance metrics.

12. The method of claim 11, wherein adjusting the one or more retrieval configurations of the RAG system based on the comparative performance metrics includes modifying at least one of:
a chunking configuration used to segment each document of the plurality of documents; or
one or more parameters of an embedding model used to generate the plurality of vector embeddings.

13. A processing system, comprising: a memory comprising computer-executable instructions; and a processor configured to execute the computer-executable instructions and cause the processing system to:
access a plurality of vector embeddings associated with a plurality of documents, wherein each vector embedding of the plurality of vector embeddings corresponds to at least a portion of a document of the plurality of documents;
cluster the plurality of vector embeddings into a plurality of clusters;
select, from each cluster of the plurality of clusters, a subset of vector embeddings of the plurality of vector embeddings according to a sampling strategy;
for each respective vector embedding of the subset of vector embeddings:
generate a seed question based on content of the portion of the document associated with the respective vector embedding;
transform the seed question into a transformed question of a question type different from the seed question; and
associate the transformed question with the respective vector embedding as a ground truth label; and
form an evaluation dataset comprising the transformed questions and their associated ground truth labels.

14. The processing system of claim 13, wherein to select the subset of vector embeddings comprises to select N/K vector embeddings from each cluster of the plurality of clusters, and N is an evaluation dataset size and K is a number of clusters.

15. The processing system of claim 13, wherein to select the subset of vector embeddings comprises to weight a selection probability based on a frequency of occurrence for content associated with each vector embedding in the plurality of documents.

16. The processing system of claim 13, wherein the question type comprises a multi-context question.

17. The processing system of claim 13, wherein:
to generate the seed question comprises to use a first language model, and
to transform the seed question into the transformed question comprises to use a second language model.

18. A method for evaluating and refining operational parameters of an information retrieval system, the method comprising:
accessing an evaluation dataset comprising a plurality of input queries and corresponding reference outputs;
applying a first configuration of the information retrieval system to at least a subset of the input queries, the first configuration specifying at least one operational parameter for locating and providing information in response to the input queries;
obtaining retrieved results from the information retrieval system for the subset of queries using the first configuration;
comparing the retrieved results to the corresponding reference outputs to determine a first performance metric;
modifying at least one operational parameter of the information retrieval system to form a second configuration that differs from the first configuration;
applying the second configuration to at least the subset of queries and obtaining updated retrieved results;
comparing the updated retrieved results to the corresponding reference outputs to determine a second performance metric; and
based on a comparison of the first performance metric and the second performance metric, selecting a configuration that improves a performance of the information retrieval system.

19. The method of claim 18, wherein the at least one operational parameter comprises a parameter comprising at least one of: a ranking algorithm parameter, an indexing strategy, a query expansion setting, an embedding model parameter, or a retrieval filter criterion.

20. The method of claim 18, wherein the performance metrics used to compare the updated retrieved results against the corresponding reference outputs comprises at least one of precision, recall, an F-score, a relevance score, or a semantic similarity measure.
